(19) United States
(12) Patent Application Publication
(10) Pub. No.: US 2024/0236832 A1
(43) Pub. Date: Jul. 11, 2024

(54) METHOD AND DEVICE FOR SUPPORTING NETWORK SLICE CHANGE IN CONSIDERATION OF NETWORK SLICE QUOTA

(71) Applicant: Samsung Electronics Co., Ltd., Gyeonggi-do (KR)

(72) Inventor: Dongeun SUH, Gyeonggi-do (KR)

(21) Appl. No.: 18/404,264

(22) Filed: Jan. 4, 2024

(30) Foreign Application Priority Data
Jan. 5, 2023 (KR) 10-2023-0001581
May 11, 2023 (KR) 10-2023-0061250
May 12, 2023 (KR) 10-2023-0061986
Sep. 25, 2023 (KR) 10-2023-0128081
Nov. 23, 2023 (KR) 10-2023-0164652

(51) Int. Cl. H04W 48/18; H04W 48/16; H04W 76/38

(52) U.S. Cl. CPC H04W 48/18; H04W 48/16; H04W 76/38

(57) ABSTRACT

A method performed by an access and mobility management function (AMF) entity in a wireless communication system is provided. A protocol data unit (PDU) session is established with respect to a terminal via a first network slice. It is determined whether replacement of the first network slice is necessary. In case that replacement is necessary, information on a second network slice is provided to the terminal. A session management (SM) context update message including the information on the second network slice is provided to a session management function (SMF) entity corresponding to the PDU session. An SM context update response message including information on whether a new PDU session is allocable to the second network slice is received from the SMF entity. Based on the SM context update response message, replacement is attempted with the second network slice, replacement is performed with another network slice, or replacement is stopped.

### CROSS-REFERENCE TO RELATED APPLICATION(S)

This application is based on and claims priority under 35 U.S.C. § 119 to Korean Patent Application Nos. 10-2023-0001581, 10-2023-0061250, 10-2023-0061986, 10-2023-0128081, and 10-2023-0164652, filed on Jan. 5, 2023, May 11, 2023, May 12, 2023, Sep. 25, 2023, and Nov. 23, 2023, in the Korean Intellectual Property Office, the disclosures of which are incorporated by reference herein in their entirety.

### BACKGROUND

### 1) Field

The disclosure relates to operations of a terminal and a base station in a wireless communication system. In particular, the disclosure relates to a method and a device for supporting a network slice change in consideration of a network slice quota in a wireless communication system.

### 2) Description of Related Art

5th generation (5G) mobile communication technologies define broad frequency bands such that high transmission rates and new services are possible, and can be implemented not only in “Sub 6 gigahertz (GHz)” bands such as 3.5 GHz, but also in “Above 6 GHz” bands referred to as millimeter wave (mmWave) including 28 GHz and 39 GHz. In addition, it has been considered to implement 6th generation (6G) mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

Since the beginning of the development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multi input multi output (MIMO) for mitigating radio-wave path loss and increasing radio-wave transmission distances in mmWave, supporting numerologies (e.g., operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods such as a low density parity check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio-unlicensed (NR-U) aimed at system operations conforming to various regulation-related requirements in unlicensed bands, new radio (NR) user equipment (UE) power saving, non-terrestrial network (NTN) which is UE-satellite direct communication for providing coverage in an area in which communication with terrestrial networks is unavailable, and positioning.

Moreover, there is ongoing standardization in air interface architecture/protocol regarding technologies, such as industrial Internet of things (IIoT), for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step random access channel (RACH) for NR). There also has been ongoing standardization in system architecture/service regarding a 5G baseline architecture (e.g., service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies, such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Embodiments provide a device and a method capable of efficiently providing a service in a wireless communication system.

According to an embodiment, a method performed by an access and mobility management function (AMF) entity in a wireless communication system may include: establishing a protocol data unit (PDU) session with respect to a terminal via a first network slice; determining whether replacement of the first network slice is necessary; when the replacement is necessary, providing information on a second network slice to the terminal; transmitting a session management (SM) context update message including the information on the second network slice to a session management function (SMF) entity corresponding to the PDU session; receiving, from the SMF entity, an SM context update response message including information on whether a new PDU session is allocable to the second network slice; and based on the received SM context update response message, attempting replacement with the second network slice, performing replacement with another network slice, or stopping replacement.

The attempting of the replacement with the second network slice, the performing of the replacement with another network slice, or the stopping of replacement may include, when the SM context update response message includes information indicating that the number of PDU sessions of the second network slice is a maximum number, attempting replacement with the second network slice, performing replacement with another network slice, or stopping replacement.

The attempting of the replacement with the second network slice, the performing of the replacement with another network slice, or the stopping of replacement may include, based on a predetermined timer value, attempting replacement with the second network slice, or transmitting a NAS message for deleting information on the second network slice to the terminal in order to stop replacement.

The method may further include acquiring load information on a plurality of network slices, and based on the load information, determining the second network slice.

The second network slice may be a network slice to replace the first network slice.

According to an embodiment, a method performed by an SMF entity in a wireless communication system may include: receiving, from an AMF entity, an SM context update message for requesting to replace, a first network slice where a PDU session with a terminal is established, with a second network slice; based on the received SM context update message, determining whether a new PDU session needs to be generated for the second network slice; based on a result of the determination, identifying whether the first network slice and the second network slice are subject to network slice admission control (NSAC); based on a result of the identification, transmitting, to a network slice admission control function (NSACF) entity, a message for requesting to decrease a number of PDU sessions of the first network slice and for requesting to increase a number of PDU sessions of the second network slice; and transmitting, to the AMF entity, an SM context update response message including information on whether a new PDU session is allocable to the second network slice.

The method may further include: requesting, from the NSACF or a network data analytics function (NWDAF), information on whether new PDU session allocation to the second network slice is possible; and receiving, from the NSACF or the NWDAF, the information on whether the new PDU session allocation to the second network slice is possible.

The information on whether the new PDU session allocation is possible may include information on whether the number of PDU sessions of the second network slice has reached a maximum value.

The method may further include receiving, from the NSACF, information on whether the request to decrease the number of PDU sessions of the first network slice and the request to increase the number of PDU sessions of the second network slice are successful.

In the method, based on the result of the identification, the message for requesting to decrease the number of PDU sessions of the first network slice and for requesting to increase the number of PDU sessions of the second network slice is transmitted via a single message.

According to an embodiment, an AMF entity in a wireless communication system may include a transceiver, and at least one processor coupled to the transceiver, wherein the at least one processor is configured to: establish a PDU session with respect to a terminal via a first network slice; determine whether replacement of the first network slice is necessary; when replacement is necessary, provide information on a second network slice to the terminal; transmit an SM context update message including the information on the second network slice to an SMF entity corresponding to the PDU session; receive, from the SMF entity, an SM context update response message including information on whether a new PDU session is allocable to the second network slice; and based on the received SM context update response message, attempt replacement with the second network slice, perform replacement with another network slice, or stop replacement.

The at least one processor may be configured to, when the SM context update response message includes information indicating that a number of PDU sessions of the second network slice is a maximum number, attempt replacement with the second network slice, perform replacement with another network slice, or stop replacement.

The at least one processor may be configured to, based on a predetermined timer value, attempt replacement with the second network slice, or transmit a NAS message for deleting information on the second network slice to the terminal in order to stop replacement.

The at least one processor may be configured to acquire load information on a plurality of network slices, and based on the load information of the plurality of network slices, determine the second network slice.

The second network slice may include a network slice to replace the first network slice.

According to an embodiment, an SMF entity in a wireless communication system may include a transceiver, and at least one processor coupled to the transceiver, wherein the at least one processor is configured to: receive, from an AMF entity, an SM context update message for requesting to replace, a first network slice where a PDU session with a terminal is established, with a second network slice; based on the received SM context update message, determine whether a new PDU session needs to be generated for the second network slice; based on a result of the determination, identify whether the first network slice and the second network slice are subject to NSAC; based on a result of the identification, transmit, to a NSACF entity, a message for requesting to decrease a number of PDU sessions of the first network slice and for requesting to increase a number of PDU sessions of the second network slice; and transmit, to the AMF entity, an SM context update response message including information on whether a new PDU session is allocable to the second network slice.

The at least one processor may be configured to request, from the NSACF or a NWDAF, information on whether a new PDU session allocation to the second network slice is possible, and receive, from the NSACF or the NWDAF, the information on whether the new PDU session allocation to the second network slice is possible.

The information on whether the new PDU session allocation is possible may include information on whether the number of PDU sessions of the second network slice has reached a maximum value.

The at least one processor may be configured to receive, from the NSACF, information on whether the request to decrease the number of PDU sessions of the first network slice and the request to increase the number of PDU sessions of the second network slice are successful.

Based on the result of the identification, the message for requesting to decrease the number of PDU sessions of the first network slice and for requesting to increase the number of PDU sessions of the second network slice may be transmitted to the NSACF entity via a single message.

The disclosure provides a device and a method capable of efficiently providing a service in a wireless communication system.

### BRIEF DESCRIPTION OF THE DRAWINGS

The above and other aspects, features, and advantages of embodiments of the disclosure will be more apparent from the following description taken in conjunction with the accompanying drawings, in which:

FIG. 1 is a diagram illustrating a communication network including core network (CN) entities in a wireless communication system, according to an embodiment;

FIG. 2 is a diagram illustrating a wireless environment including a CN in the wireless communication system, according to an embodiment;

FIG. 3 is a diagram illustrating a procedure of an AMF-based PDU session network slice change, according to an embodiment;

FIG. 4 is a diagram illustrating a structure of a terminal, according to an embodiment;

FIG. 5 is a diagram illustrating a structure of a base station, according to an embodiment; and

FIG. 6 is a diagram illustrating a structure of a network entity, according to an embodiment.

### DETAILED DESCRIPTION

Hereinafter, the operation principle of the disclosure will be described in detail with reference to the accompanying drawings. In the following description of the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

For the same reason, in the accompanying drawings, some elements may be exaggerated, omitted, or schematically illustrated. Furthermore, the size of each element does not completely reflect the actual size. In the drawings, identical or corresponding elements are provided with identical reference numerals.

The advantages and features of the disclosure and ways to achieve them will be apparent with reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference numerals designate the same or like elements.

Herein, each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block of the flowchart illustrations may represent a module, segment, or portion of code, which includes one or more executable instructions for implementing the specified logical function(s). In some alternative implementations, the functions noted in the blocks may occur out of the order. For example, two blocks shown in succession may in fact be executed substantially concurrently or the blocks may sometimes be executed in the reverse order, depending upon the functionality involved.

As used herein, the term “unit” refers to a software element or a hardware element, such as a field programmable gate array (FPGA) or an application specific integrated circuit (ASIC), which performs a predetermined function. However, the term “unit” does not always have a meaning limited to software or hardware. A unit may be constructed either to be stored in an addressable storage medium or to execute one or more processors. Therefore, a unit includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by a unit may be either combined into a smaller number of elements, or a unit, or divided into a larger number of elements, or a unit. Moreover, the elements and units or may be implemented to reproduce one or more CPUs within a device or a security multimedia card. Furthermore, a unit may include one or more processors.

Detailed descriptions of known functions or configurations incorporated herein will be omitted when it is determined that the description may make the subject matter of the disclosure unnecessarily unclear. Hereinafter, embodiments are described with reference to the accompanying drawings.

Herein, terms referring to network entities or network functions and edge computing system entities, terms referring to messages, terms referring to identification information, etc., illustratively used for the sake of descriptive convenience. Therefore, the disclosure is not limited by the terms as used below, and other terms referring to subjects having equivalent technical meanings may be used.

The disclosure is described using terms and names defined in the LTE and NR standards, which are the latest standards specified by the 3rd generation partnership project (3GPP) group among the existing communication standards, for the sake of convenience. However, the disclosure is not limited by these terms and names, and may be applied in the same way to systems that conform to other standards. In particular, the disclosure may be applied to the 3GPP 5GS/NR (5th generation mobile communication standards). Furthermore, the embodiments of the disclosure may be applied to other communication systems having similar technical backgrounds or channel types. In addition, based on determinations by those skilled in the art, the embodiments of the disclosure may be applied to other communication systems through some modifications without significantly departing from the scope of the disclosure.

A 5G mobile communication network may include a 5G UE, a 5G radio access network (RAN), and a 5G CN. The 5G CN includes NFs, such as an AMF which provides a mobility management function of a UE, an SMF which provides a session management function, a user plane function (UPF) which serves to transfer data, a policy control function (PCF) which provides a policy control function, a unified data management (UDM) which provides a function to manage data, such as subscriber data and policy control data, and a unified data repository (UDR) which stores data of various NFs such as the UDM.

In the 5G system, a network slicing technology refers to a structure and a technology enabling multiple independent logical networks virtualized in one physical network. In order to satisfy specialized requirements of a service/application, a network operator provides the service by configuring a virtual end-to-end network referred to as a network slice. A network slice is distinguished by an identifier referred to as single-network slice selection assistance information (S-NSSAI), and a network operator provides network slice(s) to a terminal to receive a service.

Specifically, in the 5G system, when registered with a network, a terminal transmits, to an AMF, identifier information (i.e., requested S-NSSAIs) for network slices that the terminal is to request, and the AMF provides the terminal with information on network slices available for the terminal in consideration of the requested S-NSSAIs, subscriber information, and the like. Even if information on the slices that the terminal requests is not provided, the AMF may provide allowed NSSAI to the terminal, in which case, the allowed NSSAI may include information (default configured NSSAI) on default configured slices and information (i.e., default subscribed S-NSSAIs) on default configured slices among subscription slices included in terminal subscriber information.

If the allowed NSSAI cannot include any slice (e.g., default configured NSSAI and default subscribed S-NSSAI are missing or unavailable), the AMF transmits, to the terminal, a network registration rejection message including a cause code indicating that registration has been rejected due to absence of an available slice.

When attempting to include any slice in the allowed NSSAI of the terminal, admission control (NSAC) and authentication (network slice-specific authentication and authorization (NSSAA)) may be performed for a corresponding slice.

In the NSAC, whether to allow the slice is determined based on the number of terminals currently registered with a specific slice and the maximum number of registered terminals allowed for the slice (i.e., determining whether to include the slice in the allowed NSSAI). Specifically, an NSACF may monitor the number of registered terminals and the number of established PDU sessions for each slice with respect to network slices subject to the NSAC, and may perform control so that the number of registered terminals and the number of established PDU sessions for each slice are maintained to be less than the maximum number of registered terminals and the maximum number of PDU sessions, respectively.

In this case, when a new terminal is registered with a slice subject to the NSAC or an existing registered terminal is de-registered, the AMF may transmit an update request message to inform the NSACF of the same. When a new PDU session is generated in a slice subject to the NSAC or an existing PDU session is released, the SMF may transmit an update request message to inform the NSACF of the same. When receiving a message informing of registration of a new terminal with the slice or a message informing of generation of a new PDU session in the slice, the NSAC may determine whether the slice is allowed for the new terminal or PDU session, based on the maximum number of terminals and maximum number of PDU sessions, and then include, in each response message, whether the slice is allowed.

For data transmission to or data reception from a specific data network (DN) via allowed slices (allowed NSSAI), the terminal may select one of the allowed slices, request, from the slice, generation of a PDU session to a specific data network name (DNN), and transmit or receive data via the generated PDU session. The PDU session includes multiple traffic flows, and the traffic flows include two types of a guaranteed bitrate quality-of-service flow (GBR QoS Flow) and a non-GBR QoS flow.

According to an embodiment, a case may occur where one or all PDU sessions included in a certain network slice need be moved to another network slice. For example, in a case where congestion has occurred in various 5G network entities belonging to a network slice, or use of a specific slice needs to be temporarily or permanently stopped due to an operational reason (e.g., replacing and upgrading equipment, etc.), in a case where corresponding traffic needs to be moved to another slice due to performance degradation of a network slice in which application traffic has been transmitted, and the like, one or all PDU sessions included in the network slice may need to be moved to another network slice.

In this case, a network slice of a PDU session, which is required to be changed (or replaced), needs to be changed to an alternative network slice. In the 5G network, the number of registered terminals and the number of established PDU sessions for each slice with respect to some slices may be monitored, and control may be performed so that the number of registered terminals and the number of established PDU sessions for each slice may be maintained to be less than the maximum number of registered terminals and the maximum number of PDU sessions, respectively.

When the alternative network slice is determined to be a slice that has already reached the maximum number of sessions, generation of a PDU session to the alternative network slice to replace an existing PDU session slice is rejected, so that continuity of application traffic is not guaranteed. Therefore, a method to solve this may be needed.

The disclosure provides a method for, during a network slice change for a PDU session, when NSAC for an alternative network slice to replace an existing network slice fails, determining another piece of S-NSSAI for the alternative network slice and making an attempt again. In addition, when a result of slice quota-based admission control for the alternative network slice of the PDU session fails, continuity of the existing PDU session can be better guaranteed via a procedure (i.e., attempting to generate a PDU session to a new alternative network slice) capable of dealing with the failure.

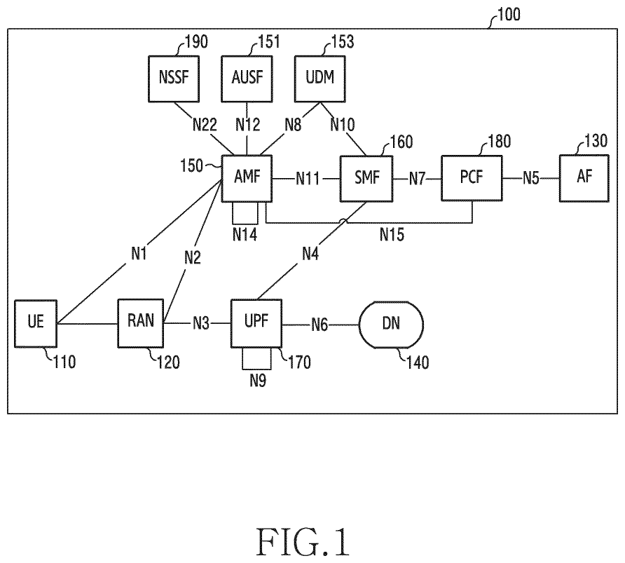

FIG. 1 is a diagram illustrating a communication network including CN entities in a wireless communication system, according to an embodiment.

The 5G mobile communication network includes a 5G UE (terminal), a 5G RAN, a base station (a 5G nodeB (gNB), an evolved nodeB (eNB), etc.), and a 5G CN. The 5G CN includes network functions, such as an AMF 150, which provides a mobility management function of a UE, an SMF 160, which provides a session management function, a UPF 170, which serves to transfer data, a PCF 180, which provides a policy control function, a UDM 153, which provides a function to manage data, such as subscriber data and policy control data, or a UDR, which stores data of various network functions.

Referring to FIG. 1, a terminal (UE) 110 may perform communication via a wireless channel (i.e., an access network), established with respect to a base station (e.g., an eNB or a gNB). In some embodiments, the terminal 110 is a device used by a user, and may be a device configured to provide a user interface (UI). For example, the UE 110 may be a terminal equipped in a vehicle for driving. In other embodiments, the terminal 110 may be a device which performs machine type communication (MTC) operated without involvement of a user, or may be an autonomous vehicle. A UE may be referred to as, in addition to an electronic device, a terminal, a vehicle terminal, a mobile station, a subscriber station, a remote terminal, a wireless terminal, a user device, or other terms having equivalent technical meanings. As a terminal, in addition to a UE, a customer-premises equipment (CPE) or a dongle type terminal may be used. Similar to a UE, a CPE may be connected to an NG-RAN node, while providing a network to another communication device (e.g., a laptop).

Referring to FIG. 1, the AMF 150 may provide a function for access and mobility management on each terminal 110 basis, and one terminal 110 may be basically connected to one AMF 150. Specifically, the AMF 150 may perform at least one function among signaling between CN nodes for mobility between 3GPP access networks, an interface (N2 interface) between radio access networks (e.g., 5G RAN) 120, NAS signaling with the terminal 110, identification of the SMF 160, and transferring and providing an SM message between the terminal 110 and the SMF 160. Some or all of the functions of the AMF 150 may be supported within a single instance of one AMF 150.

Referring to FIG. 1, the SMF 160 may provide a session management function, and when the terminal 110 has multiple sessions, each session may be managed by a different SMF 160. Specifically, the SMF 160 may perform at least one function among session management (e.g., session establishment, modification, and release including maintaining a tunnel between the UPF 170 and an access network node), selection and controlling of a UPF, configuring traffic steering for routing of traffic to an appropriate destination by the UPF 170, termination of an SM part of a NAS message, downlink data notification (DDN), and an initiator of AN-specific SM information (e.g., transferring to an access network over an N2 interface via the AMF 150). Some or all of the functions of the SMF 160 may be supported within a single instance of one SMF 160.

In a 3GPP system, a conceptual link connecting NFs in the 5G system may be referred to as a reference point. The reference point may also be referred to as an interface. The following illustrates reference points (hereinafter, used interchangeably with interfaces) included in the 5G system architecture expressed across various embodiments of the disclosure.
N1: a reference point between the UE 110 and the AMF 150
N2: a reference point between the (R)AN 120 and the AMF 150
N3: a reference point between the (R)AN 120 and the UPF 170
N4: a reference point between the SMF 160 and the UPF 170
N5: a reference point between the PCF 180 and an AF 130
N6: a reference point between the UPF 170 and a DN 140
N7: a reference point between the SMF 160 and the PCF 180
N8: a reference point between the UDM 153 and the AMF 150
N9: a reference point between two core UPFs 170
N10: a reference point between the UDM 153 and the SMF 160
N11: a reference point between the AMF 150 and the SMF 160
N12: a reference point between the AMF 150 and an authentication server function (AUSF) 151
N13: a reference point between the UDM 153 and the authentication server function 151
N14: a reference point between two AMFs 150
N15: a reference point between the PCF 180 and the AMF 150 for a non-roaming scenario, and a reference point between the PCF 180 and the AMF 150 within a visited network for a roaming scenario. In the 5G system, network slicing refers to a structure and a technology enabling multiple independent logical networks virtualized in one physical network. In order to satisfy specialized requirements of a service/application, a network operator provides the service by configuring a virtual end-to-end network referred to as a network slice. In this case, the network slice is distinguished by an identifier referred to as S-NSSAI. The network transmits a set of allowed slices (e.g., allowed NSSAI(s)) to the terminal during terminal registration (e.g., a UE registration procedure), and the terminal transmits or receives application data via a PDU session generated via one piece of the S-NSSAI (i.e., network slices).

In an embodiment, when an alternative network slice selected to replace a network slice of an existing PDU session is determined to be a slice that has already reached the maximum number of sessions, generation of a PDU session to the alternative network slice to replace the existing PDU session slice is rejected, so that continuity of application traffic is not guaranteed. Therefore, the disclosure proposes a method for solving this.

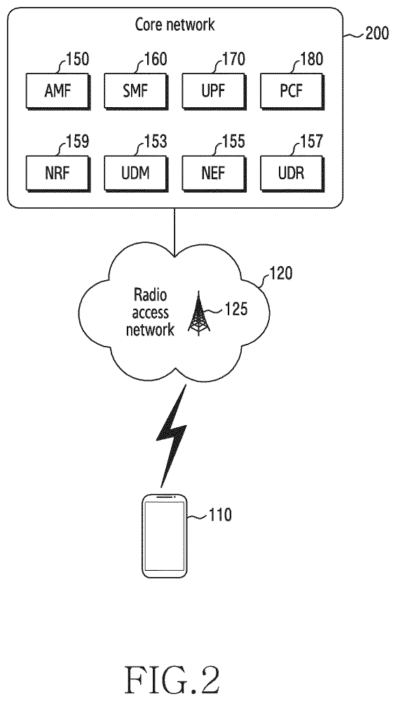

FIG. 2 is a diagram illustrating a wireless environment including a CN in the wireless communication system, according to an embodiment. Referring to FIG. 2, the wireless communication system includes the RAN 120 and a CN.

The radio access network 120 is a network directly connected to the user device, for example, the terminal 110, and is an infrastructure which provides radio access to the terminal 110. The radio access network 120 may include a set of multiple base stations including a base station 125, and the multiple base stations may perform communication via interfaces established there between. At least some of the interfaces between the multiple base stations may be wired interfaces or wireless interfaces. The base station 125 may have a structure in which a central unit (CU) and a distributed unit (DU) are separated. In this case, a single CU may control multiple DUs. The base station 125 may be referred to as, in addition to a base station, an access point (AP), a gNB, a 5G node, a wireless point, a transmission/reception point (TRP), or other terms having equivalent technical meanings. The terminal 110 may access the radio access network 120 and perform communication with the base station 125 via a wireless channel. The terminal 110 may be referred to as, in addition to a terminal, a UE, a mobile station, a subscriber station, a remote terminal, a wireless terminal, a user device, or other terms having equivalent technical meanings.

The CN is a network which manages the entire system, and the CN controls the radio access network 120 and processes data and control signals for the terminal 110, which are transmitted or received via the radio access network 120. The CN performs various functions, such as controlling a user plane and a control plane, processing mobility, managing subscriber information, charging, and interworking with other types of systems (e.g., a long-term evolution (LTE) system). In order to perform the described various functions, the CN may include multiple functionally separated entities having different NFs. For example, the CN 200 may include the AMF 150, the SMF 160, the UPF 170, and the PCF 180, a network repository function (NRF) 159, the UDM 153, a network exposure function (NEF) 155, and the UDR 157.

The terminal 110 may be connected to the radio access network 120 so as to access the AMF 150 which performs a mobility management function of the CN. The AMF 150 is a function or a device which is responsible for both access to the radio access network 120 and mobility management of the terminal 110. The SMF 160 is an NF which manages a session. The AMF 150 is connected to the SMF 160, and the AMF 150 routes a session-related message for the terminal 110 to the SMF 160. The SMF 160 makes a connection to the UPF 170 so as to allocate a user plane resource to be provided to the terminal 110, and establishes a tunnel to transmit data between the base station 125 and the UPF 170. The PCF 180 controls information on a policy and charging for a session used by the terminal 110.

The NRF 159 stores information on NFs installed in a mobile communication operator network, and performs a function to notify of the stored information. The NRF 159 may be connected to all NFs. When starting operation in the operator network, each NF provides, by registering with the NRF 159, the NRF 159 with a notification that a corresponding NR is being operated in the network. The UDM 153 is an NF which serves similarly to a home subscriber server (HSS) in a 4G network, and stores subscription information of the terminal 110 or a context used by the terminal 110 in the network.

The NEF 155 serves to connect a third party server and an NF in the 5G mobile communication system. Also, the NEF 155 serves to provide data to the UDR 157, perform updating, or acquire data. The UDR 157 serves to store subscription information of the terminal 120, store policy information, store data exposed to the outside, or store information necessary for a third party application. In addition, the UDR 157 also serves to provide the stored data to another NF.

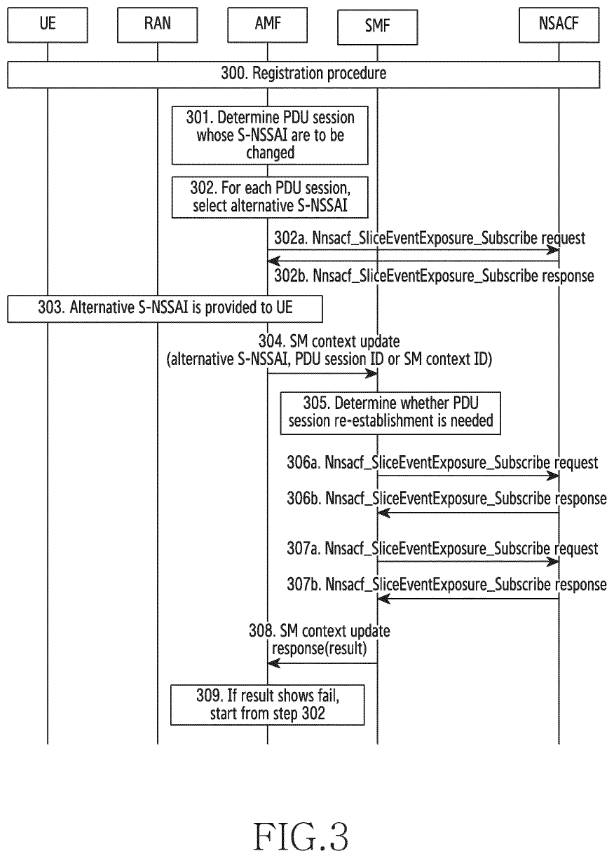

FIG. 3 is a diagram illustrating a procedure of an AMF-based PDU session network slice change according to an embodiment.

At 300, a terminal transmits a registration request message to an AMF, and the AMF performs registration and then transmits a registration accept message to the terminal. During the registration, the terminal may add support of slice re-mapping (i.e., an indicator indicating that the terminal supports slice re-mapping) to in the registration request message transmitted to the AMF. The AMF may determine whether the terminal supports a slice re-mapping function and store the same, according to whether support of slice re-mapping is included in the message received from the terminal. After receiving the registration accept message, the terminal may perform PDU session establishment, and transmit or receive application data to or from a server via PDU sessions established with respect to a specific DNN and S-NSSAI.

At 301, when the following information is received from at least one of orchestration and management (OAM), a RAN, an NWDAF, an NSACF, and a PCF, or according to configuration information of the AMF or the AMF's own determination, the AMF may determine that a slice change (or replacement) is necessary.

For example, when the AMF receives, in addition to one or more pieces of information among S-NSSAI(s), UE ID(s), and PDU session ID(s), an indicator indicating that network slices corresponding to the included information are unavailable, an indicator indicating that the network slices corresponding to the included information are required to be changed, or the like, or according to configuration information of the AMF or the AMF's own determination, the AMF may determine that a slice change (or replacement) is necessary.

According to an embodiment, when the received information includes PDU session ID(s), the AMF may determine a slice change (or replacement) only for PDU sessions of terminals, which have provided, at 300, an indicator indicating support of slice re-mapping, from among terminals that the AMF is responsible for.

When the received information includes S-NSSAI(s) and UE ID(s) or includes only S-NSSAI(s), the AMF may among corresponding UEs, determine slice changes for corresponding PDU sessions only for terminals which have provided, at 300, an indicator indicating support of slice re-mapping from among terminals that the AMF is responsible for.

Herein, for convenience of description, S-NSSAI of each PDU session, for which a change is to be made, is referred to as old S-NSSAI. At 302, the AMF may determine, for each PDU session for which an S-NSSAI change determined at 301 is to be performed, an alternative slice (i.e., alternative S-NSSAI) to be new S-NSSAI among slices excluding existing S-NSSAI of a corresponding PDU session. In this case, when there is S-NSSAI subject to NSAC from among candidate S-NSSAI(s) of the alternative S-NSSAI, the AMF may determine the alternative S-NSSAI, based on load information for the candidate S-NSSAI(s). Load information for S-NSSAI may include at least one of the current number of registered UEs and the maximum number of registered UEs for each slice and/or the current number of established PDU sessions and the maximum number of established PDU sessions for each slice.

The AMF may acquire the load information for the S-NSSAI at 302a and 302b. The AMF may acquire the load information for the S-NSSAI via the NWDAF.

At 302a, the AMF may transmit a message including the following information to the NSACF (or NWDAF) in order to acquire information to be referenced for determining the alternative S-NSSAI:
Event ID: An event ID indicating the number of registered UEs per slice and/or the number of PDU sessions per slice may be included.
Event filter: S-NSSAI(s) information of slices that may be candidates of the alternative S-NSSAI may be included.
Event reporting information: Information indicating a reporting type, wherein the event reporting information may include an immediate reporting flag for requesting an immediate response.

At 302b, the NSACF may add information on the number of registered UEs or the number of established PDU sessions to a response message transmitted to the AMF according to the event ID included in the message received from the AMF for each piece of S-NSSAI with respect to S-NSSAI(s) included in the event filter of the message received from the AMF. In addition, when the event reporting information of the message received from the AMF is configured with an immediate reporting flag, the NSACF may immediately transmit the response message to the AMF.

At 303, for the S-NSSAI of the PDU session for which a slice change has been determined at 301, if there is a single PDU session established for the terminal, the AMF may add the following information to a UE configuration update message that is to be transmitted to the terminal (i.e., UE) via the RAN:
Allowed NSSAI: A set of slice identifiers allowed to the terminal, wherein the existing S-NSSAI (i.e., old S-NSSAI) for the PDU session, for which a slice change is to be performed, in operation 302 may be excluded from the allowed NSSAI. If an identifier of the alternative slice (i.e., alternative S-NSSAI) determined at 302 is not included in the allowed NSSAI, the AMF may add the alternative S-NSSAI to the allowed NSSAI.
Alternative S-NSSAI for old S-NSSAI: Information indicating that the alternative S-NSSAI may be used instead of the old S-NSSAI may be included (i.e., both the alternative S-NSSAI and the old S-NSSAI information are included). The alternative S-NSSAI for old S-NSSAI may be transmitted in the form of mapping of allowed NSSAI, which is information indicating which other slice identifier a corresponding identifier replaces for each slice identifier included in the allowed NSSAI, or may be configured and transmitted in a different form (e.g., an information element (IE) and a separate message format transmitted to the terminal by using a non-access stratum (NAS) protocol). The alternative S-NSSAI for old S-NSSAI may include the alternative slice identifier (i.e., alternative S-NSSAI) determined at 302, and may include slice identifier information in which the alternative S-NSSAI is used instead of the existing S-NSSAI (i.e., old S-NSSAI) for the PDU session, for which a slice change is to be performed, at 302.

When the terminal receives the allowed NSSAI including no old S-NSSAI, if the alternative S-NSSAI for old S-NSSAI includes the S-NSSAI information (i.e., alternative S-NSSAI) used instead of the old S-NSSAI, PDU session(s) established with respect to the old S-NSSAI may not be released.

After receiving the alternative S-NSSAI for old S-NSSAI, when the terminal needs to transmit a new PDU session establishment request to the old S-NSSAI according to a UE local configuration or a UE route selection policy (URSP) rule stored in the terminal, a NAS message including the PDU session establishment request may include the alternative S-NSSAI and information indicating that the alternative S-NSSAI is a slice identifier that replaces the old S-NSSAI. For example, the terminal configures an S-NSSAI value, which is included in the NAS message including the PDU session establishment request, to be the alternative S-NSSAI by referring to the alternative S-NSSAI for old S-NSSAI. In addition, information, which indicates that the alternative S-NSSAI included in the NAS message including the PDU session establishment request is a value that replaces the old S-NSSAI, may be included.

At 304, when the terminal has a single PDU session established with respect to the old S-NSSAI at 301, and an S-NSSAI change has been determined for the PDU session, the AMF may transmit an SM context update message to an SMF that is responsible for the PDU session.

According to an embodiment, when the terminal has multiple PDU sessions established with respect to the old S-NSSAI at 301, the AMF may determine S-NSSAI changes for some or all of the PDU sessions, based on information received from another NF at 301, and may transmit, to the SMF, an SM context update message for each determined PDU session.

According to an embodiment, the SM context update message transmitted to the SMF by the AMF may include one pieces of the following information. The disclosure is not limited to the following examples:
Alternative S-NSSAI: The alternative S-NSSAI determined for the PDU session by the AMF may be included.
S-NSSAI: The existing S-NSSAI of the PDU session may be included.
PDU session ID or SM context ID: An identifier of the PDU session or an SM context ID for the PDU session may be included.

At 305, the SMF may determine whether it is necessary to generate a new PDU session to replace the PDU session corresponding to the SM context ID or the PDU session ID.

At 306a, when the alternative S-NSSAI received in operation 304 is subject to NSAC (i.e., a slice for which determination of acceptance is required based on the number of established PDU sessions), and a new PDU session needs to be generated (i.e., when the UE needs to re-request generation of a PDU session based on a new PDU session ID and alternative S-NSSAI, according to the information provided to the UE by the SMF), the SMF may transmit a message (e.g., Nnsacf_SliceEventExposure_Subscribe request) including at least one piece of the following information to the NSACF (or NWDAF) in order to identify in advance whether session generation via the alternative S-NSSAI is possible:
Event ID: An event ID indicating the number of registered UEs per slice may be included.
Event filter: Alternative S-NSSAI information may be included.
Event reporting information: Information indicating a reporting type, where the event reporting information may include an immediate reporting flag for requesting an immediate response.

Alternatively, at 306a, when the alternative S-NSSAI received at 304 is subject to NSAC (i.e., a slice for which determination of acceptance is required based on the number of established PDU sessions), and a new PDU session needs to be generated (i.e., when the UE needs to re-request generation of a PDU session based on a new PDU session ID and alternative S-NSSAI, according to the information provided to the UE by the SMF), the SMF may transmit a message (e.g., Nnsacf_NSAC_NumOfPDUsUpdate_Request) including at least one piece of the following information to the NSACF (or NWDAF). The disclosure is not limited to the following examples.
PDU session ID or SM context ID: An identifier of the PDU session or an SM context ID for the PDU session may be included.
UE ID: An identifier of the UE (e.g., subscription permanent identifier (SUPI)) may be included.
S-NSSAI: S-NSSAI information for which the number of PDU sessions needs to be updated may be included. When the SMF receives both the alternative S-NSSAI (i.e., the S-NSSAI determined by the AMF) and the S-NSSAI (i.e., the existing S-NSSAI) from the AMF at 304, the SMF may include the alternative S-NSSAI.
Access Type: An access type for the PDU session may be included.
update flag: Increase and decrease (which are indicators indicating increase and decrease in the number of PDU sessions for S-NSSAI, respectively) may be included.

At 306b, the NSACF may add information on the number of established PDU sessions to a response message transmitted to the SMF according to the event ID included in the message received from the SMF for each piece of S-NSSAI with respect to S-NSSAI(s) included in the event filter of the message received from the SMF. In addition, when the event reporting information of the message received from the SMF is configured with an immediate reporting flag, the NSACF may immediately transmit the response message to the SMF.

Alternatively, at 306b, when the Nnsacf_NSAC_NumOfPDUsUpdate_Request message is received from the SMF, if the update flag in the Nnsacf_NSAC_NumOfPDUsUpdate_Request message is configured as “increase”, the NSACF may identify (or determine) whether the current number of PDU sessions has reached a maximum value with respect to one or more of the UE ID, S-NSSAI, and access type included in the nsacf_NSAC_NumOfPDUsUpdate_Request message. If the current number of PDU sessions (e.g., information on the maximum number of PDU sessions for each piece of S-NSSAI, which the NSACF stores) has not reached the maximum value, the NSACF may increase the number of PDU sessions by 1, and then add information indicating success to the response message transmitted to the SMF.

If the current number of PDU sessions (e.g., information on the maximum number of PDU sessions for each piece of S-NSSAI, which the NSACF stores) has reached the maximum value, the NSACF may add, to the response message transmitted to the SMF, information (e.g., maximum number of PDU Sessions per S-NSSAI reached) indicating that the number of PDU sessions has already reached the maximum value, and/or information indicating failure.

At 307a, when the alternative S-NSSAI received along with the S-NSSAI at 304 is subject to NSAC (i.e., a slice for which determination of acceptance is required based on the number of established PDU sessions), and generation of a new PDU session is not required, or when the SMF determines to retain the existing PDU session (i.e., the SMF provides the PDU session ID of the PDU session, for which a slice change is to be performed, and the slice for change (i.e., alternative S-NSSAI) to the UPF, RAN, and UE responsible for the existing PDU session, and changes the slice of the PDU session to the alternative S-NSSAI), the SMF may transmit a message including at least one piece of information in the following to the NSACF (or NWDAF) in order to identify in advance whether the session change to the alternative S-NSSAI is possible:
PDU session ID: An event ID indicating the number of registered UEs per slice may be included.
Event filter: Alternative S-NSSAI information may be included.
Event reporting information: Information indicating a reporting type, wherein the event reporting information may include an immediate reporting flag for requesting an immediate response.

Alternatively, at 307a, when the alternative S-NSSAI received along with the S-NSSAI at 304 is subject to NSAC (i.e., a slice for which determination of acceptance is required based on the number of established PDU sessions), and generation of a new PDU session is not required, or when the SMF determines to retain the existing PDU session (i.e., the SMF provides the PDU session ID of the PDU session, for which a slice change is to be performed, and the slice for change (i.e., alternative S-NSSAI) to the UPF, RAN, and UE responsible for the existing PDU session, and changes the slice of the PDU session to the alternative S-NSSAI), the SMF may transmit a message (e.g., Nnsacf_NSAC_NumOfPDUsUpdate_Request) including at least one piece of information in the following to the NSACF (or NWDAF) (case 1). In addition, when the S-NSSAI (i.e., the S-NSSAI for the existing PDU session) received along with the alternative S-NSSAI is subject to NSAC (i.e., a slice for which determination of acceptance is required based on the number of established PDU sessions), and generation of a new PDU session is not required, or when the SMF determines to retain the existing PDU session (i.e., the SMF provides the PDU session ID of the PDU session, for which a slice change is to be performed, and the slice for change (i.e., alternative S-NSSAI) to the UPF, RAN, and UE responsible for the existing PDU session, and changes the slice of the PDU session to the alternative S-NSSAI), the SMF may transmit a message including at least one piece of information in the following to the NSACF (or NWDAF) (case 2). The messages transmitted in the two cases (case 1 and case 2) mentioned above may be transmitted in the form of one integrated message (e.g., Nnsacf_NSAC_NumOfPDUsUpdate_Request) or may be transmitted separately. Of course, the disclosure is not limited to the following examples:
PDU session ID or SM context ID: An identifier of the PDU session or an SM context ID for the PDU session may be included.
UE ID: An identifier of the UE (e.g., SUPI) may be included.
S-NSSAI: S-NSSAI information for which the number of PDU sessions needs to be updated may be included. When the SMF has received both the alternative S-NSSAI (i.e., the S-NSSAI determined by the AMF) and the S-NSSAI (i.e., the existing S-NSSAI) from the AMF at 304 and generation of a new PDU session is not required, or when the SMF determines to retain the existing PDU session, and the alternative S-NSSAI is subject to NSAC, the SMF may include the alternative S-NSSAI and configure the update flag as “increase”. In addition, when the SMF has received both the alternative S-NSSAI (i.e., the S-NSSAI determined by the AMF) and the S-NSSAI (i.e., the existing S-NSSAI) from the AMF at 304 and generation of a new PDU session is not required, or when the SMF determines to retain the existing PDU session, and the S-NSSAI (i.e., the existing S-NSSAI) is subject to NSAC, the SMF may include the S-NSSAI and configure the update flag as “decrease”.
Access Type: An access type for the PDU session may be included.
update flag: Increase and decrease (which are indicators indicating increase and decrease in the number of PDU sessions for S-NSSAI, respectively) may be included.

Alternatively, when the SMF has received both the alternative S-NSSAI (i.e., the S-NSSAI determined by the AMF) and the S-NSSAI (i.e., the existing S-NSSAI) from the AMF in operation 304, and the SMF determines to retain the existing PDU session, the SMF may add the UE ID, the PDU session ID, an NF ID, the S-NSSAI configured as the alternative S-NSSAI, the access type, and the update flag configured as “update” to the message (e.g., Nnsacf_NSAC_NumOfPDUsUpdate_Request) transmitted to the NSSF. When the S-NSSAI for the existing PDU session needs to be replaced with another S-NSSAI (e.g., alternative S-NSSAI), the SMF may configure the update flag as “update”.

At 307b, the NSACF may add information on the number of established PDU sessions to a response message transmitted to the SMF according to the event ID included in the message received from the SMF for each piece of S-NSSAI with respect to S-NSSAI(s) included in the event filter of the message received from the SMF. In addition, when the event reporting information of the message received from the SMF is configured with an immediate reporting flag, the NSACF may immediately transmit the response message to the SMF.

Alternatively, at 307b, when the Nnsacf_NSAC_NumOfPDUsUpdate_Request message is received from the SMF, if the update flag in the Nnsacf_NSAC_NumOfPDUsUpdate_Request message is configured as “increase”, the NSACF may identify (or determine) whether the current number of PDU sessions has reached a maximum value with respect to one or more of the UE ID, S-NSSAI, and access type included in the Nnsacf_NSAC_NumOfPDUsUpdate_Request message. If the current number of PDU sessions (e.g., information on the maximum number of PDU sessions for each piece of S-NSSAI, which the NSACF stores) has not reached the maximum value, the NSACF may increase the number of PDU sessions by 1, and then add information indicating success to the response message transmitted to the SMF.

Alternatively, at 307b, when the Nnsacf_NSAC_NumOfPDUsUpdate_Request message is received from the SMF, if the update flag in the Nnsacf_NSAC_NumOfPDUsUpdate_Request message is configured as “decrease”, the NSACF may decrease the current number of PDU sessions by 1 with respect to one or more of the UE ID, S-NSSAI, and access type included in the Nnsacf_NSAC_NumOfPDUsUpdate_Request message.

If the current number of PDU sessions (e.g., information on the maximum number of PDU sessions for each piece of S-NSSAI, which the NSACF stores) has reached the maximum value, the NSACF may add, to the response message transmitted to the SMF, information (e.g., maximum number of PDU Sessions per S-NSSAI reached) indicating that the number of PDU sessions has already reached the maximum value, and/or information indicating failure.

Alternatively, at 307b, when the NSACF receives the Nnsacf_NSAC_NumOfPDUsUpdate_Request message from the SMF, and the update flag in the Nnsacf_NSAC_NumOfPDUsUpdate_Request message is configured as “update”, the NSACF may change, with respect to one or more of the UE ID, PDU session ID, and access type included in the Nnsacf_NSAC_NumOfPDUsUpdate_Request message, already stored S-NSSAI information to the S-NSSAI (i.e., alternative S-NSSAI) received from the SMF, decrease the number of PDU sessions for the already stored S-NSSAI by 1, and increase the number of PDU sessions for the S-NSSAI received from the SMF by 1. For example, when the message received by the NSACF from the SMF includes UE ID, PDU session ID, and S-NSSAI_2, and the NSACF stores S-NSSAI_1 for UE ID and PDU session ID, the NSACF may change the S-NSSAI (i.e., S-NSSAI_1) stored for the UE ID and PDU session ID to S_NSSAI_2, and then decrease the number of PDU sessions for S-NSSAI_1 by 1, and the NSACF may increase the number of PDU sessions for S-NSSAI_2 by 1, if possible. When the current number of PDU sessions has not reached the maximum value for the alternative S-NSSAI included in the Nnsacf_NSAC_NumOfPDUsUpdate_Request message, the NSACF may increase the number of PDU sessions by 1, and then add result information indicating success to the response message transmitted to the SMF. If the number of current PDU sessions for the alternative S-NSSAI included in the Nnsacf_NSAC_NumOfPDUsUpdate_Request message has reached the maximum value, the NSACF may add, to the response message transmitted to the SMF, a back-off timer for AMF in addition to information (e.g., maximum number of PDU Sessions per S-NSSAI reached) indicating that the number of PDU sessions has already reached the maximum value and/or information indicating failure.

According to an embodiment, only one of 306a, 306b, 307a, and 307b may be performed depending on whether generation of a new PDU session is needed.

At 308, the SMF may determine whether a new PDU session may be assigned (or established) for the alternative S-NSSAI included in the message received from the AMF at 305, based on the information included in the message received at 306b (or 307b). For example, when it is identified, based on the information included in the message received at 306b (or 307b), that the number of PDU sessions for the alternative S-NSSAI has already reached the maximum number of PDU sessions, the SMF may include, in addition to a value indicating a result of failure included in the message transmitted to the AMF, information (e.g., “maximum number of PDU Sessions per S-NSSAI reached”), which indicates that the maximum number of PDU sessions has already been reached, as information corresponding to a cause.

If the SMF identifies, based on the information included in the message received at 306b (or 307b), that the number of PDU sessions for the alternative S-NSSAI has not yet reached the maximum number of PDU sessions, the SMF may perform a change of the S-NSSAI for the PDU session to the alternative S-NSSAI. Depending on whether to generate a new PDU session, which is determined at 305, operations may be performed as follows:
When a new PDU session needs to be generated, the SMF may include, in a message provided to the UE (terminal), the alternative S-NSSAI and the existing PDU session ID. When the message is received, the UE may transmit a message for acknowledgment to the SMF via the RAN and the AMF. In addition, when the received message includes a PDU session release command, the UE may perform release of the PDU session by transmitting, to a network, a PDU session release request message for the PDU session ID included in the message received from the SMF.

Then, the UE may generate a new PDU session by including, in a PDU session generation request message transmitted to the AMF, a PDU session ID of the released PDU session, a new PDU session ID, a DNN of the released PDU session, the old S-NSSAI, and the alternative S-NSSAI included in the received message. During the generation of the new PDU session, the AMF may include, in an SM context create request message transmitted to the SMF, the S-NSSAI (i.e., the existing S-NSSAI) and the alternative S-NSSAI (i.e., the S-NSSAI determined by the AMF) received from the UE. After the SMF receives the SM context create request message from the AMF, 306a, 306b, 308, and 309 may be performed.

When the received message includes a PDU session modification command, the UE may generate a new PDU session by including, in the PDU session generation request message transmitted to the AMF, the PDU session ID of the existing PDU session, the new PDU session ID, the DNN of the existing PDU session, the old S-NSSAI, and the alternative S-NSSAI included in the received message. During the generation of the new PDU session, the AMF may include, in the SM context create request message transmitted to the SMF, the S-NSSAI (i.e., the existing S-NSSAI) and the alternative S-NSSAI (i.e., the S-NSSAI determined by the AMF) received from the UE. After the SMF receives the SM context create request message from the AMF, 306a, 306b, 308, and 309 may be performed. When the new PDU session is generated, the UE may perform release of the PDU session by transmitting, to the network, the PDU session release request message for the PDU session ID of the existing PDU session.
When generation of a new PDU session is not needed, the SMF may change the S-NSSAI of the existing PDU session to the alternative S-NSSAI by including, in the message transmitted to the UPF, RAN, and UE responsible for the PDU session corresponding to the PDU session ID or SM context ID received in operation 304, the PDU session ID, the alternative S-NSSAI, and information for requesting a slice change.

At 309, when a result indicating failure (i.e., failure in processing the request for network slice replacement) is included in the message received at 308 (e.g., when a cause indicating “maximum number of PDU sessions per S-NSSAI reached” is included (i.e., SM context update failure)), the AMF may perform 302 again. In this case, when new alternative S-NSSAI is determined at 302, the previous alternative S-NSSAI requested at 304 may be excluded. Based on the newly determined alternative S-NSSAI, the AMF may perform 303 (i.e., including the newly determined alternative S-NSSAI in the UE configuration update message transmitted to the terminal) and 304 (i.e., including the newly determined alternative S-NSSAI in the SM context update message transmitted to the SMF).

Alternatively, when the message received at 309 includes a result indicating failure (i.e., failure in processing the request for network slice replacement) (e.g., when a cause indicating “maximum number of PDU sessions per S-NSSAI reached” is included (i.e., when the SM context update has failed)), the AMF may transmit a network slice change message back to the SMF after expiration of a timer, based on a timer value stored in the configuration information or the back-off timer for AMF value received from NSACF at 307b. In this case, 302 may be performed again for the same alternative S-NSSAI, and when a network slice replacement request fails again at 309, the AMF may double the timer value and then transmit a network slice replacement request message to the SMF again after the timer expires.

When a result indicating failure (i.e., failure in processing the request for network slice replacement) is included in the message received at 309 (e.g., when a cause indicating “maximum number of PDU sessions per S-NSSAI reached” is included (i.e., when the SM context update has failed)), the AMF may cancel (or suspend) network slice change (e.g., network slice replacement) for the UE. When the AMF determines to cancel (or suspend) network slice replacement after the message including the alternative S-NSSAI for old S-NSSAI has already been transmitted to the UE, the AMF may transmit, to the UE, a NAS message for deleting the allowed S-NSSAI for old S-NSSAI stored in the UE.

When the AMF determines to cancel network slice replacement after the message including configured NSSAI or the allowed NSSAI including the alternative S-NSSAI has already been transmitted to the UE, the AMF may transmit, to the UE, a NAS message including the configured NSSAI excluding the alternative S-NSSAI and/or the allowed NSSAI excluding the alternative S-NSSAI.

Alternatively, according to an embodiment, after receiving, from the SMF(s), all response message(s) to the SM context update messages transmitted for slice replacement to the SMF(s), only when all the response message(s) include information indicating success, the AMF may transmit, to the UE, the message of 303, which is transmitted for network slice replacement.

According to an embodiment, a method performed by an AMF entity in a wireless communication system may include: establishing a PDU session with respect to a terminal via a first network slice; determining whether replacement of the first network slice is necessary; when the replacement is necessary, providing information on a second network slice to the terminal; transmitting an SM context update message including the information on the second network slice to an SMF entity corresponding to the PDU session; receiving, from the SMF entity, an SM context update response message including information on whether a new PDU session is allocable to the second network slice; and based on the received SM context update response message, attempting replacement with the second network slice, performing replacement with another network slice, or stopping replacement.

The attempting of the replacement with the second network slice, the performing of the replacement with another network slice, or the stopping of replacement may include, when the SM context update response message includes information indicating that a number of PDU sessions of the second network slice is a maximum number, attempting replacement with the second network slice, performing replacement with another network slice, or stopping replacement.

The attempting of the replacement with the second network slice, the performing of the replacement with another network slice, or the stopping of replacement may include, based on a predetermined timer value, attempting replacement with the second network slice, or transmitting a NAS message for deleting information on the second network slice to the terminal in order to stop replacement.

The method may further include acquiring load information on a plurality of network slices, and based on the load information of the plurality of network slices, determining the second network slice.

The second network slice may be a network slice to replace the first network slice.

According to an embodiment, a method performed by an SMF entity in a wireless communication system may include: receiving, from an AMF entity, an SM context update message for requesting to replace, a first network slice where a PDU session with a terminal is established, with a second network slice; based on the received SM context update message, determining whether a new PDU session needs to be generated for the second network slice; based on a result of the determination, identifying whether the first network slice and the second network slice are subject to NSAC; based on a result of the identification, transmitting, to an NSACF entity, a message for requesting to decrease a number of PDU sessions of the first network slice and for requesting to increase a number of PDU sessions of the second network slice; and transmitting, to the AMF entity, an SM context update response message including information on whether a new PDU session is allocable to the second network slice.

The method may further include requesting, from the NSACF or an NWDAF, information on whether new PDU session allocation to the second network slice is possible, and receiving, from the NSACF or the NWDAF, the information on whether the new PDU session allocation to the second network slice is possible.

The information on whether the new PDU session allocation is possible may include information on whether the number of PDU sessions of the second network slice has reached a maximum value.

The method may further include receiving, from the NSACF, information on whether the request to decrease the number of PDU sessions of the first network slice and the request to increase the number of PDU sessions of the second network slice are successful.

In the method, based on the result of the identification, the message for requesting to decrease the number of PDU sessions of the first network slice and for requesting to increase the number of PDU sessions of the second network slice is transmitted via a single message.

According to an embodiment, an AMF entity in a wireless communication system may include a transceiver, and at least one processor coupled to the transceiver, wherein the at least one processor is configured to: establish a PDU session with respect to a terminal via a first network slice; determine whether replacement of the first network slice is necessary; when the replacement is necessary, provide information on a second network slice to the terminal; transmit an SM context update message including the information on the second network slice to an SMF entity corresponding to the PDU session; receive, from the SMF entity, an SM context update response message including information on whether a new PDU session is allocable to the second network slice; and based on the received SM context update response message, attempt replacement with the second network slice, perform replacement with another network slice, or stop replacement.

The at least one processor may be configured to, when the SM context update response message includes information indicating that a number of PDU sessions of the second network slice is a maximum number, attempt replacement with the second network slice, perform replacement with another network slice, or stop replacement.

The at least one processor may be configured to, based on a predetermined timer value, attempt replacement with the second network slice, or transmit a NAS message for deleting information on the second network slice to the terminal in order to stop replacement.

The at least one processor may be configured to acquire load information on multiple network slices, and based on the load information of the multiple network slices, determine the second network slice.

The second network slice may include a network slice to replace the first network slice.

According to an embodiment, an SMF entity in a wireless communication system may include a transceiver, and at least one processor coupled to the transceiver, wherein the at least one processor is configured to: receive, from an AMF entity, an SM context update message for requesting to replace, a first network slice where a PDU session with a terminal is established, with a second network slice; based on the received SM context update message, determine whether a new PDU session needs to be generated for the second network slice; based on a result of the determination, identify whether the first network slice and the second network slice are subject to NSAC; based on a result of the identification, transmit, to an NSACF entity, a message for requesting to decrease a number of PDU sessions of the first network slice and for requesting to increase a number of PDU sessions of the second network slice; and transmit, to the AMF entity, an SM context update response message including information on whether a new PDU session is allocable to the second network slice.

The at least one processor may be further configured to request, from the NSACF or an NWDAF, information on whether new PDU session allocation to the second network slice is possible, and receive, from the NSACF or the NWDAF, the information on whether the new PDU session allocation to the second network slice is possible.

The information on whether the new PDU session allocation is possible may include information on whether the number of PDU sessions of the second network slice has reached a maximum value.

The at least one processor may be configured to receive, from the NSACF, information on whether the request to decrease the number of PDU sessions of the first network slice and the request to increase the number of PDU sessions of the second network slice are successful.

Based on the result of the identification, the message for requesting to decrease the number of PDU sessions of the first network slice and for requesting to increase the number of PDU sessions of the second network slice may be transmitted to the NSACF entity via a single message.

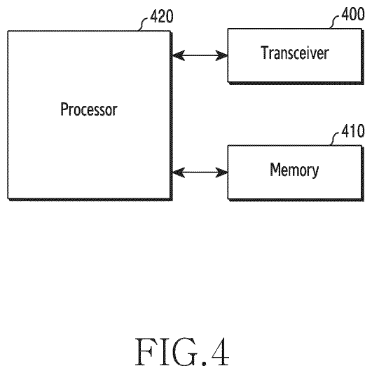

FIG. 4 is a block diagram illustrating a structure of a terminal (UE), according to an embodiment.

As illustrated in FIG. 4, a terminal of the disclosure may include a processor 420, a transceiver 400, and a memory 410. However, the elements of the terminal are not limited to the above examples. For example, the terminal may include more elements or fewer elements than the aforementioned elements. In addition, the processor 420, the transceiver 400, and the memory 410 may be implemented in the form of a single chip.

According to an embodiment, the processor 420 may control a series of procedures enabling the terminal to operate according to the aforementioned embodiments of the disclosure. For example, the processor 420 may control the elements of the terminal to perform the method of supporting a network slice change according to the aforementioned embodiments. The processor 420 may control, by executing a program stored in the memory 410, the elements of the terminal to perform the aforementioned embodiments of the disclosure. In addition, the processor 420 may be an application processor, a communication processor (CP), a circuit, an application-specific circuit, or at least one processor.

According to an embodiment, the transceiver 400 may transmit a signal to or receive a signal from a network entity, another terminal, or a base station. A signal transmitted to or received from a network entity, another terminal, or a base station may include control information and data. The transceiver 400 may include an RF transmitter configured to perform up-conversion and amplification of a frequency of a transmitted signal, an RF receiver configured to perform low-noise amplification of a received signal and perform down-conversion of a frequency, and the like. However, elements of the transceiver 400 are not limited to the RF transmitter and the RF receiver. Further, the transceiver 400 may receive a signal via a wireless channel, output the signal to the processor 420, and transmit, through the wireless channel, a signal output from the processor 420.

According to an embodiment, the memory 410 may store a program and data necessary for operations of the terminal. In addition, the memory 410 may store control information or data included in a signal transmitted or received by the terminal. The memory 410 may include storage media, such as a ROM, a RAM, a hard disk, a CD-ROM, and a DVD, or a combination of storage media. In addition, there may be multiple memories 410. In addition, the memory 410 may store a program for performing the aforementioned method of supporting a network slice change.

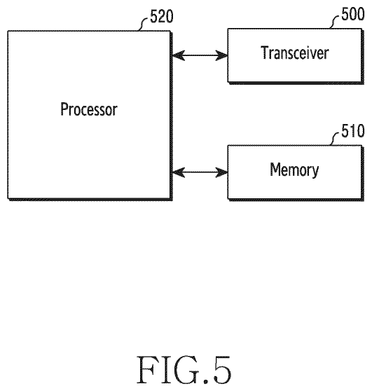

FIG. 5 is a block diagram illustrating a structure of a base station, according to an embodiment.

As illustrated in FIG. 5, a base station of the disclosure may include a processor 520, a transceiver 500, and a memory 510. However, the elements of the base station are not limited to the above examples. For example, the base station may include more elements or fewer elements than the aforementioned elements. In addition, the processor 520, the transceiver 500, and the memory 510 may be implemented in the form of a single chip.

According to an embodiment, the processor 520 may control a series of procedures enabling the base station to operate as described above. For example, the processor 520 may control the elements of the base station to perform the method of supporting a network slice change, as described above. The processor 520 may control, by executing a program stored in the memory 510, the elements of the base station to perform the aforementioned embodiments. In addition, the processor 520 may be an application processor, a CP, a circuit, an application-specific circuit, or at least one processor.

According to an embodiment, the transceiver 500 may transmit a signal to or receive a signal from a network entity, another base station, or a terminal. A signal transmitted to or received from a network entity, another base station, or a terminal may include control information and data. The transceiver 500 may include an RF transmitter configured to perform up-conversion and amplification of a frequency of a transmitted signal, an RF receiver configured to perform low-noise amplification of a received signal and perform down-conversion of a frequency, and the like. However, elements of the transceiver 500 are not limited to the RF transmitter and the RF receiver. Further, the transceiver 500 may receive a signal via a wireless channel, output the signal to the processor 520, and transmit, through the wireless channel, a signal output from the processor 520.

According to an embodiment, the memory 510 may store a program and data necessary for operations of the base station. The memory 510 may store control information or data included in a signal transmitted or received by the base station. The memory 510 may include storage media, such as a read only memory (ROM), a random access memory (RAM), a hard disk, a compact disc-ROM (CD-ROM), and a digital versatile disc (DVD), or a combination of storage media. In addition, there may be multiple memories 510. In addition, the memory 510 may store a program for performing the aforementioned method of supporting a network slice change.

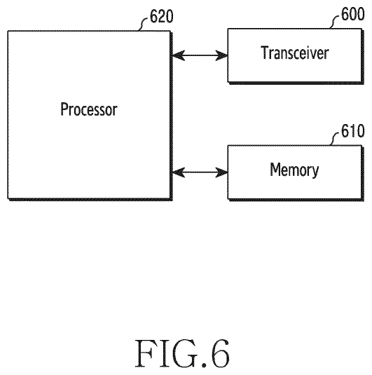

FIG. 6 is a block diagram illustrating a structure of a network entity, according to an embodiment.

As illustrated in FIG. 6, a network entity of the disclosure may include a processor 620, a transceiver 600, and a memory 610. However, the elements of the network entity are not limited to the above examples. For example, the network entity may include more elements or fewer elements than the aforementioned elements. In addition, the processor 620, the transceiver 600, and the memory 610 may be implemented in the form of a single chip. In addition, the network entity may refer to a NF, and the NF may include a RAN, an AMF, a PCF, a UDM, an AF, an NEF, and a UTM.

According to an embodiment, the processor 620 may control a series of procedures enabling the NF to operate, as described above. For example, the processor 620 may control the elements of the network entity to perform the method of supporting a network slice change, as described above. The processor 620 may control, by executing a program stored in the memory 610, the elements of the network entity to perform the aforementioned embodiments. In addition, the processor 620 may be an application processor, a CP, a circuit, an application-specific circuit, or at least one processor.

According to an embodiment, the transceiver 600 may transmit a signal to or receive a signal from another network entity, a base station, or a terminal. A signal transmitted to or received from another network entity, a base station, or a terminal may include control information and data. The transceiver 600 may include an RF transmitter configured to perform up-conversion and amplification of a frequency of a transmitted signal, an RF receiver configured to perform low-noise amplification of a received signal and perform down-conversion of a frequency, and the like. However, this is merely an embodiment of the transceiver 600, and elements of the transceiver 600 are not limited to the RF transmitter and the RF receiver. Further, the transceiver 600 may receive a signal via a wireless channel, output the signal to the processor 620, and transmit, through the wireless channel, a signal output from the processor 620.

According to an embodiment, the memory 610 may store a program and data necessary for operations of the network entity. The memory 610 may store control information or data included in a signal transmitted or received by the network entity. The memory 610 may include storage media, such as a ROM, a RAM, a hard disk, a CD-ROM, and a DVD, or a combination of storage media. In addition, there may be multiple memories 610. In addition, according to an embodiment, the memory 610 may store a program for performing the aforementioned method of supporting a network slice change.

It should be noted that the configuration diagrams, illustrative diagrams of control/data signal transmission methods, and illustrative diagrams of operation procedures illustrated FIGS. 1 to 6 are not intended to limit the protection scope of embodiments of the disclosure. That is, all constituent elements, entities, or operation steps described in FIGS. 1 to 6 should not be construed as being essential for the implementation of the disclosure, and the disclosure may be implemented without impairing the essential features of the disclosure by including only some constituent elements.

The operations in the above-described embodiments may be implemented by providing any unit in the device with a memory device storing corresponding program codes. That is, a controller in the device may perform the above-described operations by reading and executing the program codes stored in the memory device by means of a processor or central processing unit (CPU).

Various units or modules of an entity or a terminal device described in the disclosure may be operated using hardware circuits such as complementary metal oxide semiconductor-based logic circuits, firmware, or hardware circuits such as combinations of software and/or hardware and firmware and/or software embedded in a machine-readable medium. For example, various electrical structures and methods may be implemented using transistors, logic gates, and electrical circuits such as application-specific integrated circuits.

The methods according to various embodiments described in the claims or the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the disclosure as defined by the appended claims and/or disclosed herein.

The programs (software modules or software) may be stored in non-volatile memories including a random access memory and a flash memory, a ROM, an electrically erasable programmable read only memory (EEPROM), a magnetic disc storage device, a CD-ROM, DVDs, or other type optical storage devices, or a magnetic cassette. Alternatively, any combination of some or all of them may form a memory in which the program is stored. Further, a plurality of such memories may be included in the electronic device.

In addition, the programs may be stored in an attachable storage device which may access the electronic device through communication networks such as the Internet, Intranet, local area network (LAN), wide LAN (WLAN), and storage area network (SAN) or a combination thereof. Such a storage device may access the electronic device via an external port. Further, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments, but should be defined by the appended claims and equivalents thereof.

What is claimed is:

1. A method performed by an access and mobility management function (AMF) entity in a wireless communication system, the method comprising:
establishing a protocol data unit (PDU) session with respect to a terminal via a first network slice;
determining whether replacement of the first network slice is necessary;
in case that replacement is necessary, providing information on a second network slice to the terminal;
transmitting a session management (SM) context update message comprising the information on the second network slice to a session management function (SMF) entity corresponding to the PDU session;
receiving, from the SMF entity, an SM context update response message comprising information on whether a new PDU session is allocable to the second network slice; and
based on the SM context update response message, attempting replacement with the second network slice, performing replacement with another network slice, or stopping replacement.

2. The method of claim 1, wherein attempting replacement with the second network slice, performing replacement with another network slice, or stopping replacement comprises:
in case that the SM context update response message comprises information indicating that a number of PDU sessions of the second network slice is a maximum number, attempting replacement with the second network slice, performing replacement with another network slice, or stopping replacement.

3. The method of claim 1, wherein attempting replacement with the second network slice, performing replacement with another network slice, or stopping replacement comprises:
based on a predetermined timer value, attempting replacement with the second network slice, or transmitting a NAS message for deleting information on the second network slice to the terminal in order to stop replacement.

4. The method of claim 1, further comprising:
acquiring load information on a plurality of network slices; and
based on the load information, determining the second network slice.

5. The method of claim 1, wherein the second network slice is a network slice to replace the first network slice.

6. A method performed by a session management function (SMF) entity in a wireless communication system, the method comprising:
receiving, from an access and mobility management function (AMF) entity, an SM context update message for requesting to replace a first network slice where a protocol data unit (PDU) session with a terminal is established, with a second network slice;
based on the received SM context update message, determining whether a new PDU session needs to be generated for the second network slice;
based on a result of the determination, identifying whether the first network slice and the second network slice are subject to network slice admission control (NSAC);
based on a result of the identification, transmitting, to a network slice admission control function (NSACF) entity, a message requesting to decrease a number of PDU sessions of the first network slice and requesting to increase a number of PDU sessions of the second network slice; and
transmitting, to the AMF entity, an SM context update response message comprising information on whether a new PDU session is allocable to the second network slice.

7. The method of claim 6, further comprising:
requesting, from the NSACF or a network data analytics function (NWDAF), information on whether new PDU session allocation to the second network slice is possible; and
receiving, from the NSACF or the NWDAF, the information on whether the new PDU session allocation to the second network slice is possible.

8. The method of claim 7, wherein the information on whether the new PDU session allocation is possible comprises information on whether the number of PDU sessions of the second network slice has reached a maximum value.

9. The method of claim 6, further comprising receiving, from the NSACF, information on whether the request to decrease the number of PDU sessions of the first network slice and the request to increase the number of PDU sessions of the second network slice are successful.

10. The method of claim 6, wherein, based on the result of the identification, the message for requesting to decrease the number of PDU sessions of the first network slice and for requesting to increase the number of PDU sessions of the second network slice is transmitted via a single message.

11. An access and mobility management function (AMF) entity in a wireless communication system, the AMF entity comprising:
a transceiver; and
at least one processor coupled to the transceiver,
wherein the at least one processor is configured to:
establish a protocol data unit (PDU) session with respect to a terminal via a first network slice;
determine whether replacement of the first network slice is necessary;
in case that replacement is necessary, provide information on a second network slice to the terminal;
transmit a session management (SM) context update message comprising the information on the second network slice to a session management function (SMF) entity corresponding to the PDU session;
receive, from the SMF entity, an SM context update response message comprising information on whether a new PDU session is allocable to the second network slice; and
based on the SM context update response message, attempt replacement with the second network slice, perform replacement with another network slice, or stop replacement.

12. The AMF entity of claim 11, wherein the at least one processor is configured to, in case that the SM context update response message comprises information indicating that a number of PDU sessions of the second network slice is a maximum number, attempt replacement with the second network slice, perform replacement with another network slice, or stop replacement.

13. The AMF entity of claim 11, wherein the at least one processor is configured to, based on a predetermined timer value, attempt replacement with the second network slice, or transmit a NAS message for deleting information on the second network slice to the terminal in order to stop replacement.

14. The AMF entity of claim 11, wherein the at least one processor is configured to:
acquire load information on a plurality of network slices; and
based on the load information, determine the second network slice.

15. The AMF entity of claim 11, wherein the second network slice is a network slice to replace the first network slice.

16. A session management function (SMF) entity in a wireless communication system, the SMF entity comprising:
a transceiver; and
at least one processor coupled to the transceiver,
wherein the at least one processor is configured to:
receive, from an access and mobility management function (AMF) entity, an SM context update message for requesting to replace, a first network slice where a protocol data unit (PDU) session with a terminal is established, with a second network slice;
based on the received SM context update message, determine whether a new PDU session needs to be generated for the second network slice;
based on a result of the determination, identify whether the first network slice and the second network slice are subject to network slice admission control (NSAC);
based on a result of the identification, transmit, to a network slice admission control function (NSACF) entity, a message requesting to decrease a number of PDU sessions of the first network slice and requesting to increase a number of PDU sessions of the second network slice; and
transmit, to the AMF entity, an SM context update response message comprising information on whether a new PDU session is allocable to the second network slice.

17. The SMF entity of claim 16, wherein the at least one processor is further configured to:
request, from the NSACF or a network data analytics function (NWDAF), information on whether new PDU session allocation to the second network slice is possible; and
receive, from the NSACF or the NWDAF, the information on whether the new PDU session allocation to the second network slice is possible.

18. The SMF entity of claim 17, wherein the information on whether the new PDU session allocation is possible comprises information on whether the number of PDU sessions of the second network slice has reached a maximum value.

19. The SMF entity of claim 16, wherein the at least one processor is configured to, receive, from the NSACF, information on whether the request to decrease the number of PDU sessions of the first network slice and the request to increase the number of PDU sessions of the second network slice are successful.

20. The SMF entity of claim 16, wherein, based on the result of the identification, the message for requesting to decrease the number of PDU sessions of the first network slice and for requesting to increase the number of PDU sessions of the second network slice is transmitted to the NSACF entity via a single message.
